(19) United States
(12) Patent Application Publication
(10) Pub. No.: US 2001/0056486 A1
(43) Pub. Date: Dec. 27, 2001

(54) Network monitoring system and network monitoring method

(75) Inventor: Masahiko Kosaka, Kawasaki-shi (JP)

Correspondence Address: ROSSI & ASSOCIATES, P.O. BOX 826, ASHBURN, VA, 20146-0826, US

(73) Assignee: FastNet, Inc.

(21) Appl. No.: 09/875,606

(22) Filed: Jun. 6, 2001

(30) Foreign Application Priority Data
Jun. 15, 2000 (JP) 2000-180125

(51) Int. Cl. G06F 15/16; G06F 15/173

(52) U.S. Cl. 709/224; 709/202

(57) ABSTRACT

There are provided a network monitoring system and a network monitoring method which are capable of obtaining results of monitoring devices on a network with accuracy. Monitor probe servers are provided in respective different layers of a network to determine operating states of devices on the network. A monitor server monitors the operating states of the devices on the network, based on the output from the monitor probe servers. The monitor probe servers transmit monitoring commands to the devices on the network, receives responses to the commands from the devices, and outputs the received responses to the monitor server, which in turn analyzes the responses received from the monitor probe servers, and displays results of the analysis.

### BACKGROUND OF THE INVENTION

1. Field of the Invention

This invention relates to a network monitoring system and a network monitoring method for effectively monitoring a large-scale network such as the Internet.

2. Prior Art

In conventional network systems, generally a monitor server determines operating states of devices on the Internet in response to a monitoring command (ping command). The ping command is implemented by echo and echo reply packets according to ICMP (RFC792: Internet Control Message Protocol).

Further, a methodf checking operating states of devices on a network is widely used, which utilizes the SNMP (Simple Network Management Protocol) provided in network devices. Network management systems utilizing these protocols have been devised.

FIG. 12 is a block diagram showing the schematic arrangement of a conventional network monitoring system.

The conventional network monitoring system is comprised of a monitor server 1 that monitors devices 2 to be monitored, provided on a network, a monitor client 3 that is used by an administrator of the network to display results of monitoring by the monitor server 1 on a display device such as a computer screen.

The monitor client 3 sends a signal FA1 instructing setting of items to be monitored and the like to the monitor server 1. The monitor server 1 sets items to be monitored and the like according to the signal FA1, and then transmits a monitoring command FA2 to the devices 2. The devices 2 return a response FA3 to the monitoring command FA2 to the monitor server 1, which in turn stores this response, i.e. results of monitoring. If the signal FA1 contains instructions for state analysis and display, the monitor server 1 carries out a state analysis process based on the stored results of monitoring, and sends data FA4 indicative of results of the analysis to the monitor client 3, which in turn displays the data.

FIG. 13 is a diagram showing the structure of a network in which the conventional network monitoring system is incorporated.

The conventional network is roughly comprised of a network operation center (NOC) 100, and a network 200, which are connected to each other via a private line or ISDN.

The network operation center 100 is comprised of the monitor server 1, the monitor client 3, and a router 10. In the network 200, a router 12 is provided in a first layer which is the uppermost layer, and a router 11 for remote communication with the router 10 via a private line for example, a server 13, and a router 14 are provided in a second layer, the router 14 bridging between the second layer and a third layer. Further, the third layer includes servers 15 and 16, and a router 17 bridging between the third layer and a fourth layer. The router 17 is connected to routers 18, 19 and 20 provided in the fourth layer. In FIG. 13, the devices 2 to be monitored in FIG. 12 correspond to the routers 12, 14, 17, 18, 19, and 20 and the servers 13, 15, and 16.

In FIG. 13, the two-dot chain lines A designate communication lines such as network cables for use in data communication, the thin solid lines B extending from the monitor server 1 to the routers 12, 14, 17, 18, 19, and 20 and the servers 13, 15, and 16 designate monitoring commands sent from the monitor server 1, and the broken lines C extending from the routers 12, 14, 17 and 18 and the server 13 designate responses to the monitoring commands.

The monitor server 1 operates in response to monitoring instructions preset by the monitor client 3 to send monitoring commands which are respective predetermined types of commands to the above-mentioned devices to be monitored, at respective predetermined time intervals, and the devices return responses to their respective received monitoring commands to the monitor server 1, which in turn stores these responses, i.e. monitoring results.

In the conventional network monitoring system, however, the monitor server 1 is remotely located from the network 200 in which are provided the devices to be monitored, namely, the routers 12, 14, 17, 18, 19 and 20 and the servers 13, 15, and 16 such that the monitoring commands sent from the monitor server 1 are transmitted via a different network (in the illustrated system, the private line or ISDN) from the devices. Consequently, the monitoring results can be affected by the conditions of the different network.

### SUMMARY OF THE INVENTION

It is an object of the present invention to provide a network monitoring system and a network monitoring method which are capable of obtaining results of monitoring devices on a network with accuracy.

To attain the above object, in a first aspect of the present invention, there is provided a network monitoring system comprising first monitoring means for determining operating states of devices on a network, and second monitoring means for monitoring the operating states of the devices on the network, based on an output from the second monitoring means.

In a preferred form of the first aspect, the second monitoring means comprises acquiring means for acquiring the output from the first monitoring means, analysis means for analyzing the acquired output from the first monitoring means, and display means for displaying results of the analysis.

More preferably, the display means displays the results of the analysis in a tree structure representation according to an arrangement of the devices on the network.

In a preferred form of the first aspect, the first monitoring means comprises transmitting means for transmitting monitoring commands to the devices on the network, receiving means for receiving responses to the monitoring commands from the devices on the network, and output means for outputting the received responses to the second monitoring means.

In a preferred embodiment of the first aspect, the first monitoring means comprises a plurality of monitor probe servers, the monitor probe servers determining the same devices on the network.

More preferably, the monitor probe servers are provided in respective different layers of the network.

In an advantageous embodiment of the first aspect, the network monitoring system according to the first aspect further comprises storage means for storing the output from the first monitoring means in a storage device, and the first monitoring means regularly transmit monitoring commands to the devices on the network using the transmitting means, receives responses to the monitoring commands from the devices on the network using the receiving means, and output the received responses to the second monitoring means using the output means, the storage means stores the output from the first monitoring means in the storage device, and the second monitoring means analyzes the output from the first monitoring means stored by the storage means every predetermined sampling time period using the analysis means.

More advantageously, the storage means stores the output from the first monitoring means in the storage device by overwriting the output onto the storage device starting with a first area thereof after writing the output onto the storage device up to a last area thereof.

To attain the above object, in a second aspect of the present invention, there is provided a network monitoring system comprising first monitoring means having collecting means for collecting data indicative of results of monitoring devices on a network, and output means for outputting the collected data, and second monitoring means having storage means for storing the output data, analysis means for analyzing the stored data, and display means for displaying the analyzed data.

To attain the above object, in a third aspect of the present invention, there is provided a network monitoring method comprising an operating state-determining step of determining operating states of devices on a network using first monitoring means, and an operating state-monitoring step of monitoring the operating states of the devices on the network, based on an output from the first monitoring means, using second monitoring means.

In a preferred form of the third aspect, the operating state-monitoring step comprises an acquiring step of acquiring the output from the first monitoring means, an analysis step of analyzing the acquired output from the first monitoring means, and a display step of displaying results of the analysis.

More preferably, the display step comprises displaying the results of the analysis in a tree structure representation according to an arrangement of the devices on the network.

In a preferred form of the third aspect, the operating state-determining step comprises a transmitting step of transmitting monitoring commands to the devices on the network, a receiving step of receiving responses to the monitoring commands from the devices on the network, and an output step of outputting the received responses to the second monitoring means for use in monitoring the operating states of the devices on the network in the operating state-monitoring step.

In a preferred embodiment, the first monitoring means comprises a plurality of monitor probe servers, the operating state-determining step comprising determining the same devices on the network by the monitor probe servers.

In an advantageous embodiment of the third aspect, the network monitoring method further comprises a storing step of storing the output from the first monitoring means in a storage device, and in the operating state-determining step, the transmitting step comprises regularly transmitting monitoring commands to the devices on the network, the receiving step comprises receiving responses to the monitoring commands from the devices on the network, and the output means comprises outputting the received responses to the second monitoring means for use in monitoring the operating states of the devices on the network in the operating state-monitoring step, the storing means comprises storing the output from the first monitoring means in the storage device, and in the operating state-monitoring step, the analysis step comprises analyzing the output from the first monitoring means stored in the storing step every predetermined sampling time period.

More advantageously, the storing step comprises storing the output from the first monitoring means in the storage device by overwriting the output onto the storage device starting with a first area thereof after writing the output onto the storage device up to a last area thereof.

To attain the above object, in a fourth aspect of the present invention, there is provided a network monitoring method comprising a first monitoring step having a collecting step of collecting data indicative of results of monitoring devices on a network, and an output step of outputting the collected data, and a second monitoring step having a storing step of storing the output data, an analysis step of analyzing the stored data, and a display step of displaying the analyzed data.

According to the first and third aspects, a function of determining operating states of devices on a network and a function of monitoring the operating states of the devices on the network are separately provided. As a result, the monitoring results can never be affected by the conditions of a different network connected between the network to be monitored and a network operation center, whereby results of monitoring of devices on the network can be obtained with higher accuracy.

Since the analyzed monitoring results are displayed in a tree structure representation according to the arrangement of the devices to be monitored on the network, the user can visually determine the monitoring results with ease. Besides, the user can easily identify a location where a fault occurs on the network.

Further, since the same devices to be monitored are doubly monitored by a plurality of monitor probe servers as the first monitoring means, results of monitoring of the devices on the network can be obtained with higher accuracy.

Still further, since the plurality of monitor probe servers are provided in respective different layers of the network, monitoring results can be obtained with reliability.

Moreover, since monitoring commands are regularly transmitted to the devices to be monitored on the network, responses to the commands from the devices are received and output to be stored, and the stored responses are analyzed every predetermined sampling time period, more averaged monitoring results can be obtained.

Further, the output from the first monitoring means, i.e. the monitoring results are overwritten onto the storage device starting with the first area thereof after writing onto the result file up to the last area thereof, up-to-date monitoring results over the past sampling time period, five minutes, for example, can be obtained.

According to the second and fourth aspects, a function of collecting data indicative of results of monitoring the network and a function of storing the collected data, and analyzing and displaying the stored data are separately provided. As a result, the monitoring results can never be affected by the conditions of a different network connected between the network to be monitored and a network operation center, whereby results of monitoring of devices on the network can be obtained with higher accuracy.

The above and other objects of the invention will become more apparent from the following detailed description taken in conjunction with the accompanying drawings.

### BRIEF DESCRIPTION OF THE DRAWINGS

FIG. 1 is a block diagram schematically showing the arrangement of a network monitoring system according to an embodiment of the present invention;

FIG. 2 is a diagram showing the structure of a network in which the network monitoring system of FIG. 1 is incorporated;

FIG. 3 is a diagram showing the structure of another network in which the network monitoring system of FIG. 1 is incorporated;

FIG. 4 is a diagram showing monitoring results when a fault occurs in a router 14 of the network 200 of FIG. 3;

FIG. 5 is a diagram showing an example of the topology of the network 200, which is displayed on a monitor client 3;

FIG. 6 is a diagram showing another example of the topology of the network 200, which is displayed on the monitor client 3;

FIG. 7 is a diagram showing still another example of the topology of the network 200, which is displayed on the monitor client 3;

FIG. 8 is a diagram showing an example of a display screen of the monitor client 3 when a fault occurs in the router 14 of the network 200;

FIG. 9 is a diagram showing an example of a configuration file set for a monitor probe server 4 or a monitor probe server 6;

FIG. 10 is a diagram useful in explaining timing in which monitoring commands are transmitted in a general network;

FIG. 11 is a diagram useful in explaining timing in which monitoring commands are transmitted in the network 200 of FIG. 1 incorporating the network monitoring system according to the embodiment of the present invention;

FIG. 12 is a block diagram showing the schematic arrangement of a conventional network monitoring system; and

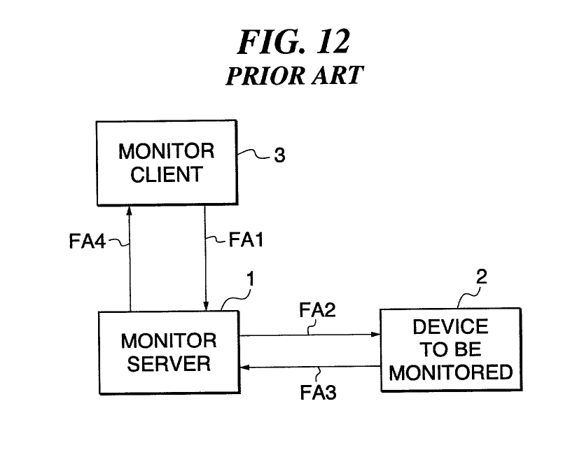

FIG. 13 is a diagram showing the structure of a network in which the conventional network monitoring system of FIG. 12 is incorporated.

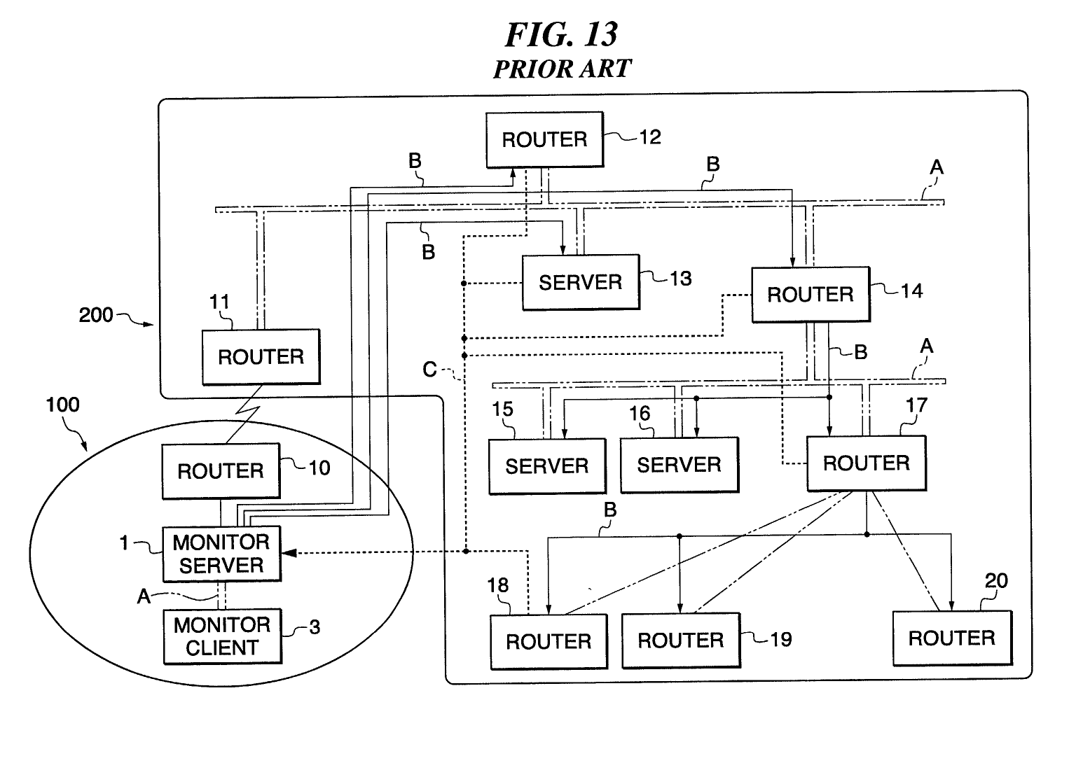

### DETAILED DESCRIPTION OF PREFERRED EMBODIMENT

The present invention will now be described in detail with reference to drawings showing a preferred embodiment thereof.

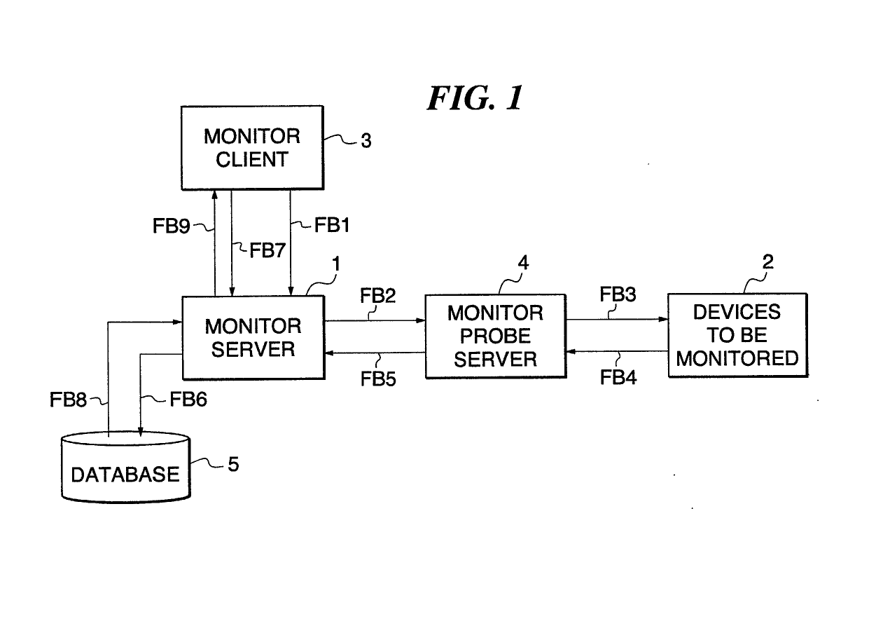

FIG. 1 is a block diagram schematically showing the arrangement of a network monitoring system according to an embodiment of the present invention.

The network monitoring system according to the present embodiment is comprised of a monitor server (second monitoring means) 1, devices 2 to be monitored, a monitor client 3, a monitor probe server (first monitoring means) 4, and a database 5.

The monitor server 1 registers network information on the devices 2, and creates a configuration file to be transmitted to the monitor probe server 4. Further, the monitor server 1 has a function of receiving monitoring results from the monitor probe server 4 and storing them in the database 5, and a function of analyzing the stored monitoring results upon receiving a reading request from the monitor client 3. The database 5 may be incorporated in the monitor server 1.

The monitor client 3 is a machine used by the administrator to determine operating states of the devices 2, and the monitor client 3 may also serve as the monitor server 1.

The monitor probe server 4 transmits a monitoring command directly to the devices 2 according to configuration information created by the monitor server 1, and upon receipt of a response to the command, checks the operating states of the devices 2 based on the received response.

Actual operations taking out in the network monitoring system according to the present embodiment are roughly comprised of (i) setting of devices 2 to be monitored, (ii) actual monitoring and collection and storage of results of the monitoring, and (iii) reading of the monitoring results. In FIG. 1, reference numerals FB1 and FB2 designate an operation of setting the devices 2, FB3 to FB6 operations of actual monitoring and collection and storage of results of the monitoring, and FB7 to FB9 an operation of reading the monitoring results.

Next, the operations designated by the reference numerals FB1 to FB9 will be described in the order mentioned.

First, the monitor client machine 3 transmits the network information on the devices 2 and other information such as monitoring items to the monitor server 1 (FB1). The monitor server 1 creates the configuration file based on these information and transfers the configuration file to the monitor probe server 4 (FB2). The monitor probe server 4 transmits monitoring commands for monitoring the network, based on the received configuration file, to the devices 2 (FB3), and receives responses to the commands from the devices 2 (FB4). At this time, if any device 2 is not operating, the monitor server 1 cannot receive the response to the monitoring command. Therefore, if no response to the monitoring command has been received after the lapse of a certain time period, the monitor probe server 4 creates a response to the effect that the corresponding device 2 is not operating.

Then, the monitor probe server 4 transmits monitoring results to the monitor server 1 (FB5), and the monitor server 1 stores the received monitoring results in the database 5 (FB6).

Thereafter, when the monitor client 3 issues a reading request for monitoring results to the monitor server 1 (FB7), the monitor server 1 acquires data indicative of the monitoring results according to the reading request from the database 5 and analyzes the acquired data (FB8). Then, the monitor server 1 transmits results of the analysis to the monitor client 3 (FB9).

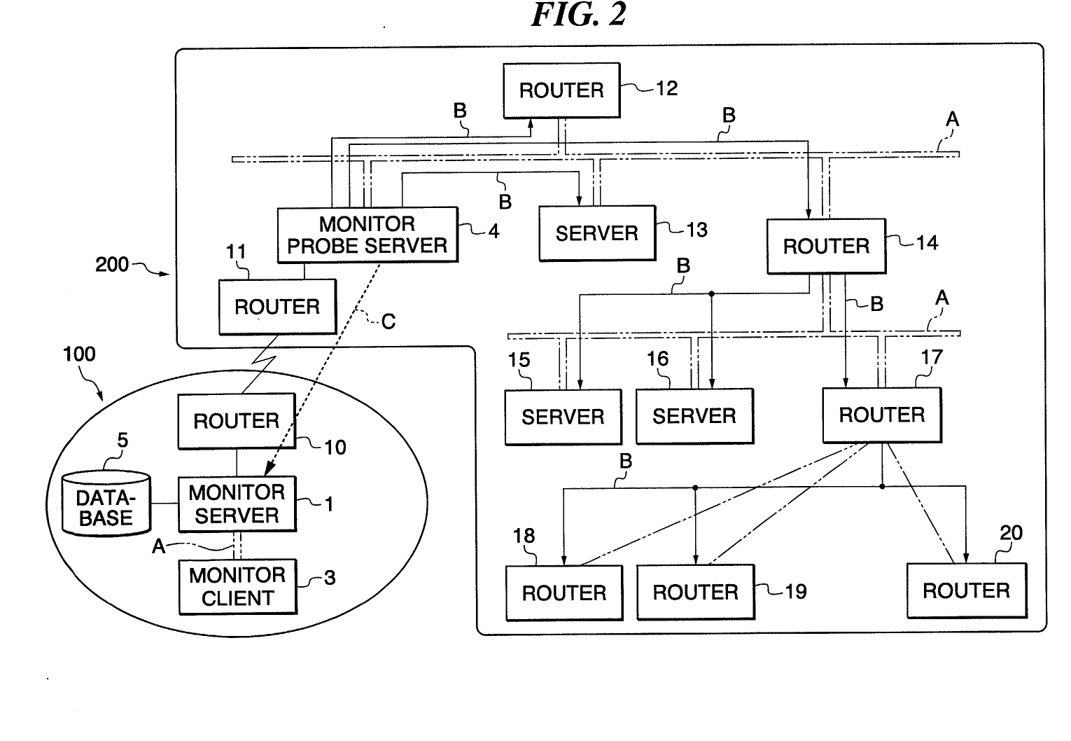

FIG. 2 is a diagram showing the structure of a network in which the network monitoring system of FIG. 1 is incorporated. The network with the network monitoring system according to the present embodiment incorporated therein is roughly comprised of a network operation center (NOC) 100, and a network 200, which are connected to each other via a private line or ISDN.

The network operation center 100 is comprised of the monitor server 1, monitor client 3, and a router 10. In the network 200, a router 12 is provided in a first layer which is the uppermost layer of the network 200; the monitor probe server 4, a server 13, and a router 14 are provided in a second layer, the router 14 bridging between the second layer and a third layer; and servers 15 and 16 and a router 17 are provided in the third layer, the router 17 bridging between the third layer and a fourth layer. The monitor probe server 4 is connected to a router 11 that carries out remote communication with the router 10, via a private line for example, and the router 17 is connected to routers 18, 19 and 20 provided in the fourth layer. In FIG. 2, the devices 2 to be monitored in FIG. 1 correspond to the routers 12, 14, 17, 18, 19, and 20 and the servers 13, 15, and 16.

In FIG. 2, the two-dot chain lines A designate communication lines such as network cables for use in data communication, the thin solid lines B extending from the monitor probe server 4 to the routers 12, 14, 17, 18, 19, and 20 and the servers 13, 15, and 16 designate monitoring commands sent from the monitor probe server 4, and the broken lines C extending from the monitor probe server 4 to the monitor server 1 designate monitoring results.

The monitor probe server 4 operates in response to monitoring instructions preset by the monitor client 3 to send monitoring commands which are respective predetermined types of commands to the above-mentioned devices to be monitored, at respective predetermined time intervals, and the devices return responses to their respective received monitoring commands to the monitor probe server 4, which in turn transmits the monitoring results to the monitor server 1 via the routers 10, 11. The monitor server stores the received monitoring results in the database 5.

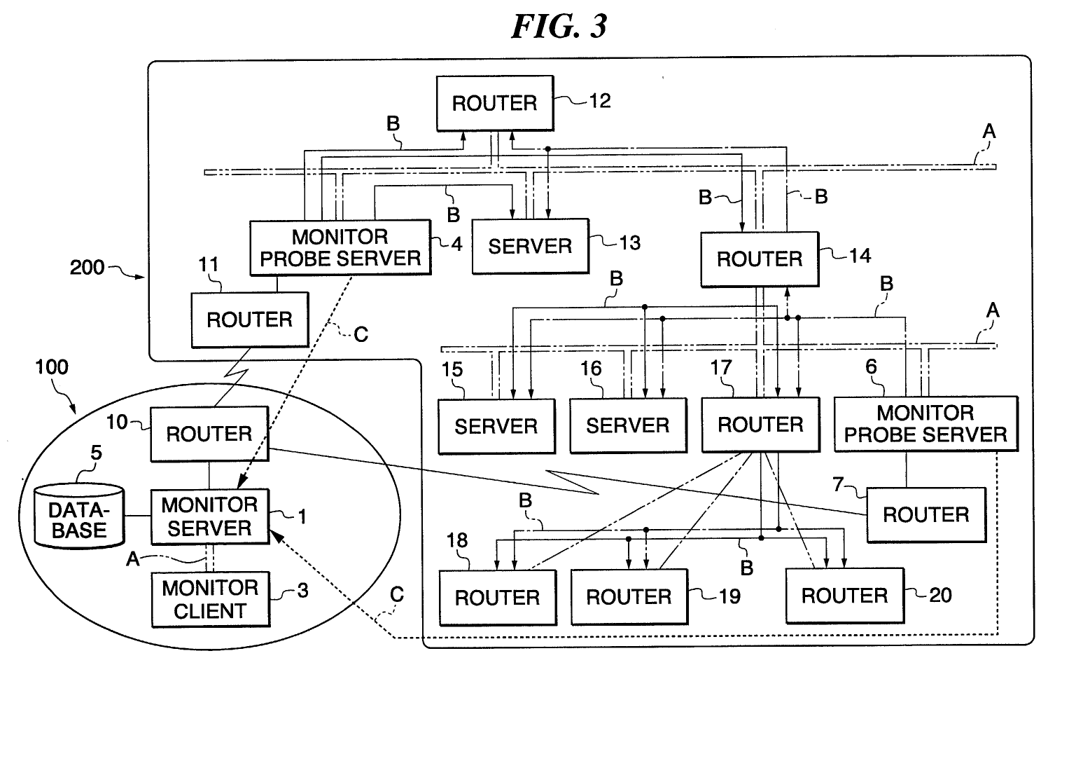

FIG. 3 is a diagram similar to FIG. 2, showing the structure of another network in which the network monitoring system of FIG. 1 is incorporated. The structure of FIG. 3 is different from that of FIG. 2 in that a monitor probe server 6 and a router 7 connected to the monitor probe server 6 are additionally provided in the third layer of the network 200.

The monitor probe server 6 has a similar function to the monitor probe server 4, namely, it operates in response to monitoring instructions preset by the monitor client 3 to send monitoring commands which are respective predetermined types of commands to the above-mentioned devices to be monitored, at respective predetermined time intervals. The devices return responses to their respective received monitoring commands to the monitor probe server 6, which in turn transmits the responses or monitoring results to the monitor server 1 via the routers 7, 10. The monitor server 1 stores the received monitoring results in the database 5.

In this network 200, the devices to be monitored are doubly monitored by the monitor probe server 4 and the monitor prober server 6 provided in a different layer from the monitor prober server 4.

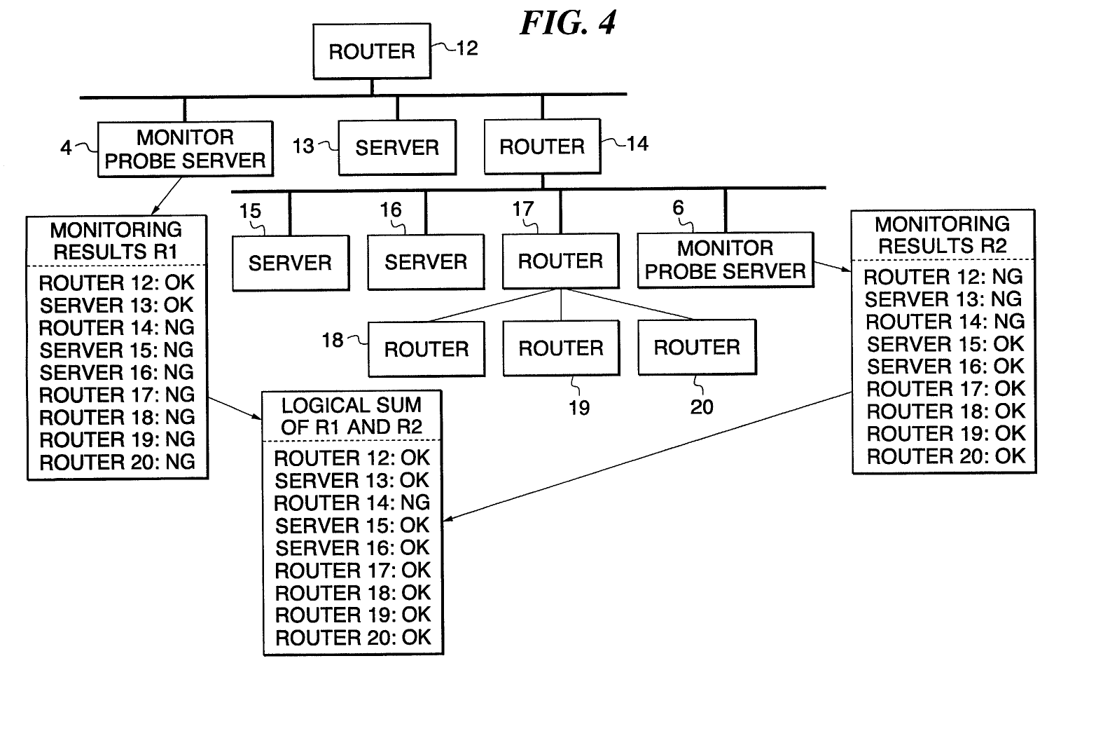

FIG. 4 is a diagram showing monitoring results when a fault occurs in the router 14 of the network 200 of FIG. 3.

In the event of occurrence of a fault in the router 14, the monitor probe server 4 acquires a monitoring result R1, and the monitor prove server 6 acquires a monitoring result R2. In the monitoring results R1 and R2, “OK” indicates that the monitored device is normal, and “NG” indicates that the monitored device is abnormal.

Since the router 14 bridges between the second layer and the third layer of the network 200, according to the monitoring result R1 obtained by the monitor probe server 4, “OK” is displayed for the router 12 provided in the first layer and the server 13 provided in the same layer (second layer) as the monitor probe server 4, while “NG” is displayed for the router 14 in which the fault occurs, and the routers 17 to 20 and the servers 15 and 16, which are in the third and lower layers.

On the other hand, according to the monitoring result R2 obtained by the monitor probe server 6, “NG” is displayed for the router 12 in the first layer and the server 13 and the faulty router 14 in the second layer, while “OK” is displayed for the servers 15 and 16 and the router 17 which are in the same layer (third layer) as the monitor probe server 6 and the routers 18 to 20 which are in the fourth layer.

The monitor probe servers 4, 6 transmit the respective monitoring results R1 and R2 to the monitor server 1, and the monitor server 1 stores the received monitoring results R1 and R2 in the database 5. Upon receipt of a command request for reading monitoring results from the monitor client 3, the monitor server 1 reads the monitoring results R1 and R2 from the database 5, obtains a logical sum of the monitoring results R1 and R2 to thereby specify the device in which a fault actually occurs (in this case, the router 14), and transmits information on the specified device to the monitor client 3.

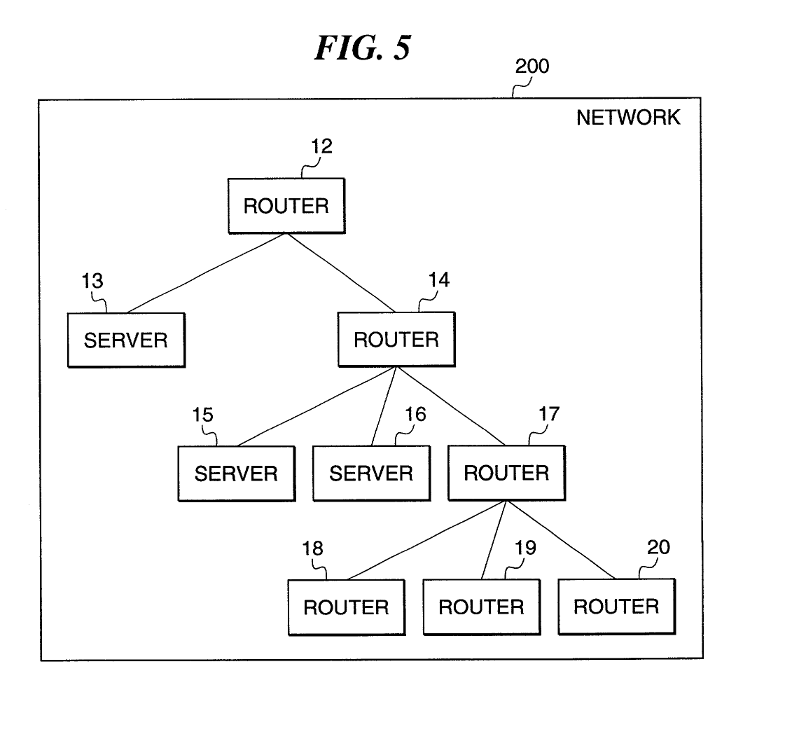

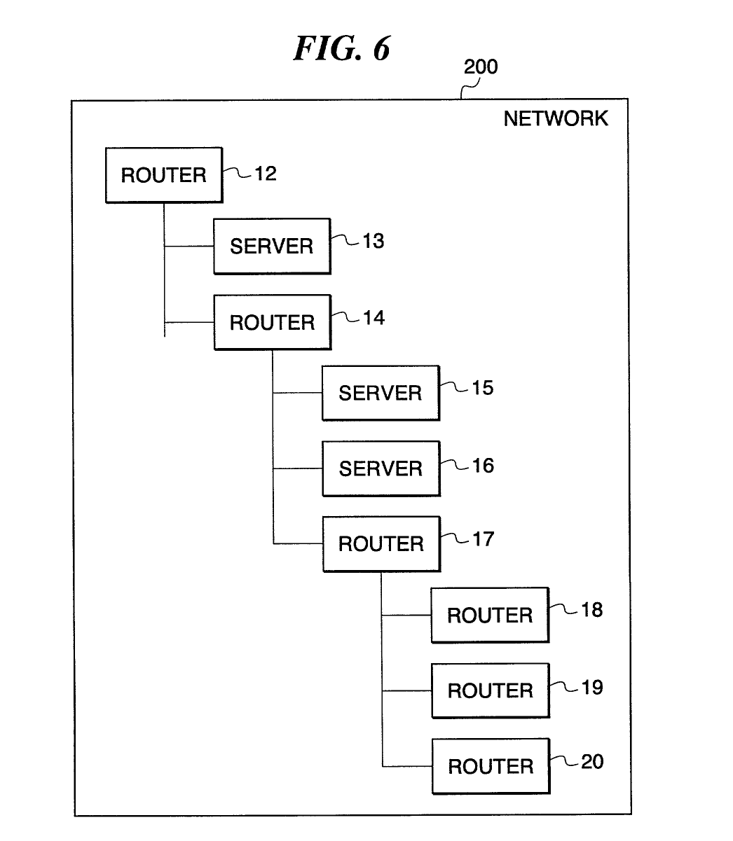

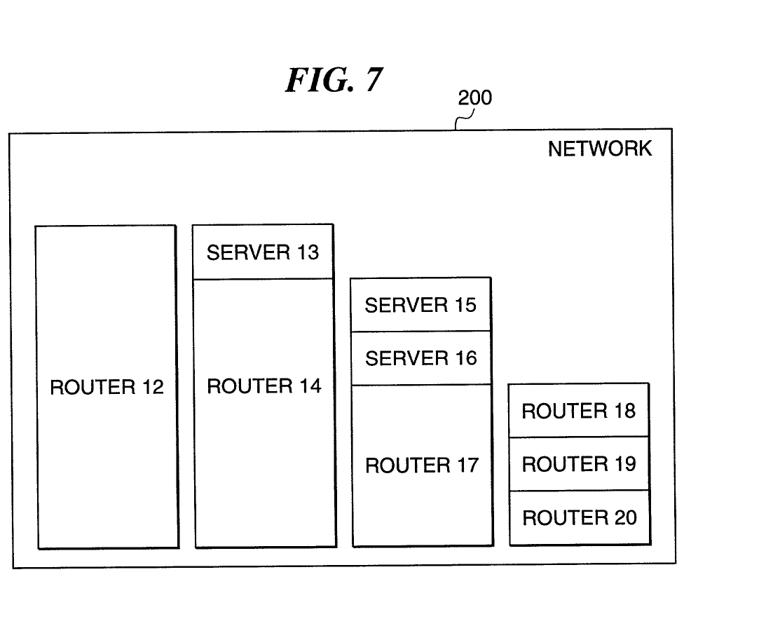

FIGS. 5 to 7 shows examples of the topology of the network 200 which are displayed on the monitor client 3. FIG. 5 shows a general tree structure representation which is close to the actual connection of the network components on the network 200, FIG. 6 is a three structure representation which is structured so as to represent the network component connection in a realistic form, and FIG. 7 shows a representation in the form of a table which is easy to use when observing information on the monitor server 1 using a user interface to the Web, for example. It should be noted that the representations of FIGS. 5 to 7 are mere examples and not limitative. However, since they represent the topology of the network 200, they are common in that the first layer of the network 200 is displayed at the uppermost portion of the display screen or at the leftmost portion thereof.

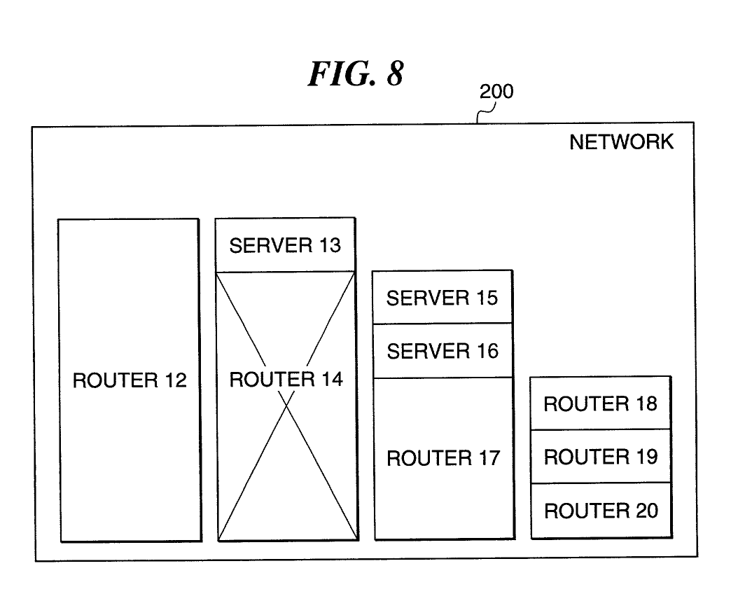

When a fault actually occurs in the router 14, the faulty router 14 is displayed as being crossed out as shown in FIG. 8. Alternatively, the faulty router 14 alone may be displayed in a different color, e.g. red, from the other devices. These manners of display enable the user to visually determine a device in which a fault occurs, with ease.

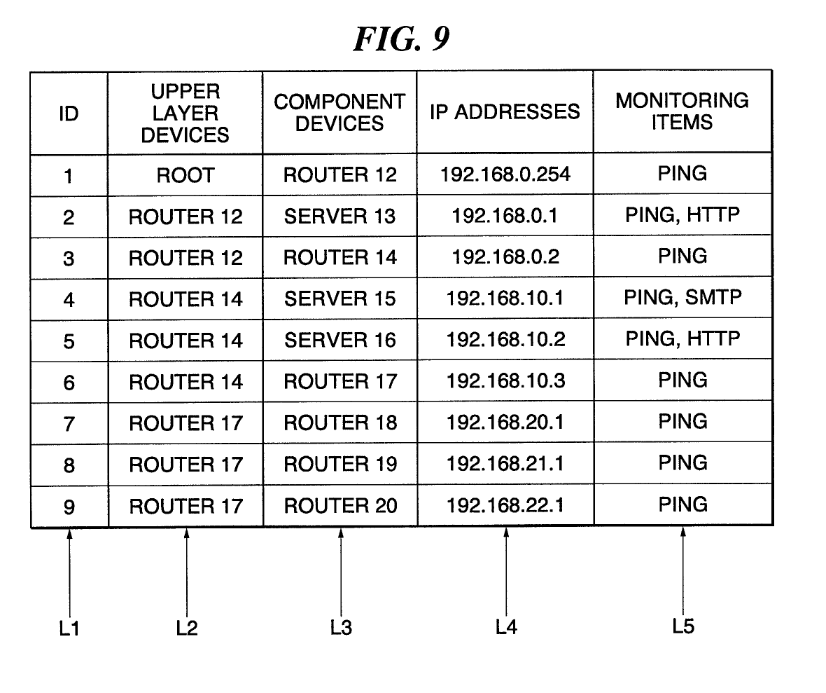

FIG. 9 is a diagram showing an example of the configuration file set for the monitor probe server 4 or the monitor probe server 6.

The configuration file is provided with five fields. In a field L1, ID numbers that specify respective devices to be monitored are described. The devices to be monitored are managed according to the ID numbers. In a field L2, the names of component devices in upper layers among the component devices of the network 200 are described. By holding this field L2, the structure of the network 200 can be displayed in any of the tree structure representations as shown in FIGS. 5 to 7. In a field L3, the names of the component devices are described. The names described in the field L3 must be unique and correspond to the names specified in the field L2. In a field L4, IP addresses of the component devices are described. In actual operation, the monitor probe servers 4, 6 issue monitoring commands to the IP addresses. Alternatively, component devices to which monitoring commands are to be issued may be designated by what is called the domain name of the host (Fully Qualified Domain Name: FQDN) using the domain name service (DNS). In a field L5, items to be monitored (monitoring items) concerning the component devices are described. Actual monitoring is carried out by issuing monitoring commands according to corresponding monitoring items described in the field L5 to designated ones of the IP addresses in the field L4.

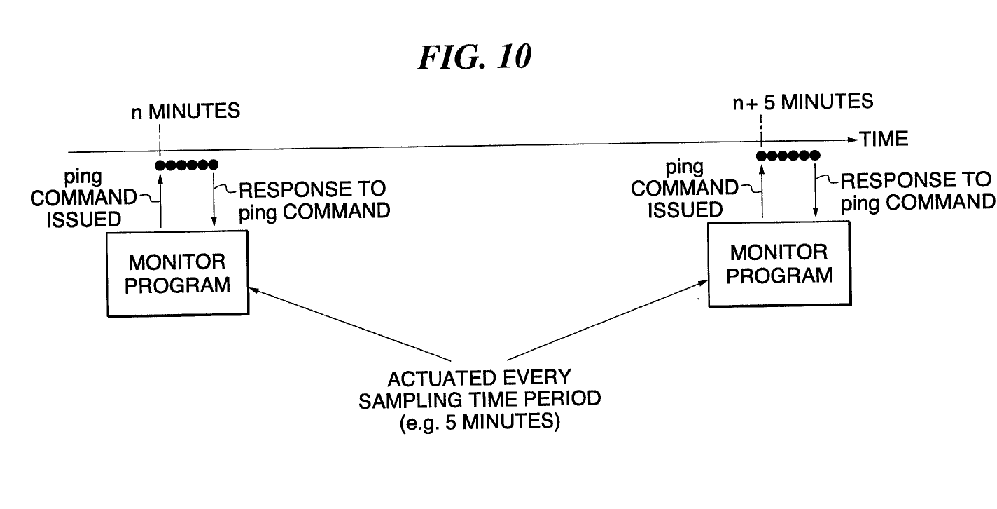

FIG. 10 is a diagram useful in explaining timing in which monitoring commands are transmitted in a general network.

In monitoring component devices of a general network, a monitor server provided with a monitoring program sends a monitoring command (ping command or the like) to each device to be monitored every five minutes or every ten minutes and receives a response from the latter.

The monitor server actuates the monitoring program every five minutes or every ten minutes, and sends monitoring commands three to five times in the case of checking the operating state of each device or ten to several tens of times in the case of measuring quality such as packet loss, at time intervals of several hundreds of milliseconds to approximately 1 second.

The monitor server stores monitoring results obtained over a time period of several seconds during which the monitoring has been carried out, as typical values of monitoring results obtained every five minutes or every ten minutes. Thus, results of monitoring carried out over a very short time period of several seconds are recognized as typical values of monitoring results over five minutes or ten minutes. Further, the monitor server sends the monitoring commands to all the devices to be monitored at almost the same time. Consequently, where a large number of devices are to be monitored, there can occur a problem of traffic of the monitoring commands.

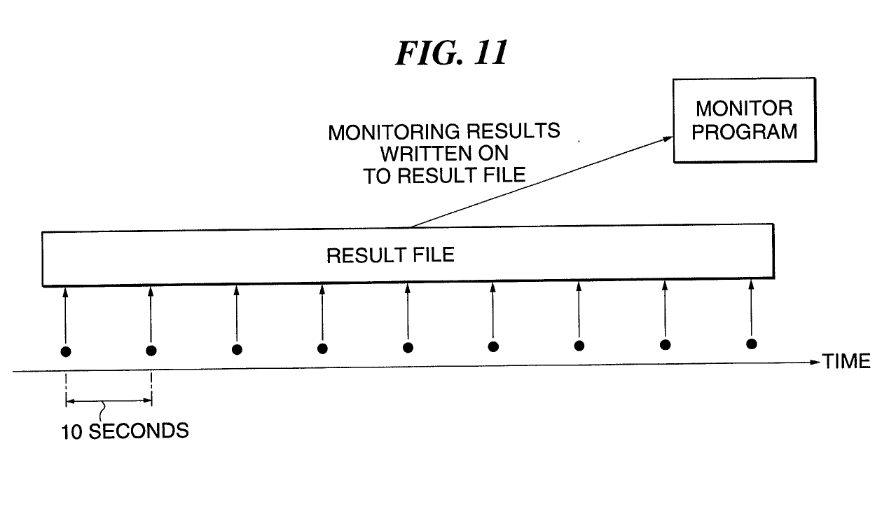

To avoid these disadvantages, according to the present embodiment, as shown in FIG. 11, the monitor probe servers 4, 6 constantly send monitoring commands every 10 seconds, for example, instead of-sending monitoring commands every five or ten minutes, and receive responses to the commands. The monitor probe servers 4, 6 constantly transmit the received responses to the monitor server 1, and the monitor server 1 stores the received responses in a result file in the database 5.

For example, where the monitor probe servers 4, 6 carry out monitoring by regularly sending monitoring commands every ten seconds over a sampling time period of five minutes, thirty responses are obtained. In this case, the database 5 acts like a ring buffer such that after part of the responses is written onto the result file up to the last area thereof, a continued part of the responses is overwritten onto the result file starting with the first area thereof, and the monitoring program provided in the monitor server 1 simply evaluates the contents of the whole result file whenever the sampling time period (five minutes) elapses, whereby results of the monitoring over the past five minutes can be obtained. Thus, more averaged monitoring results can be obtained. By sequentially storing the averaged results of monitoring over five minutes in a file other than the result file, monitoring results can always be obtained without a discontinuity.

As described above, according to the present embodiment, the monitor probe servers 4, 6 that actually collect data of monitoring results of the network are additionally provided separately from the monitor server 1 that actually stores, analyzes and displays the monitoring results. As a result, the monitoring results can never be affected by the conditions of a different network connected between the network to be monitored and the network operation center, whereby results of monitoring of devices on the network can be obtained with higher accuracy.

Further, the devices to be monitored are doubly monitored by the monitor probe server 4 and the monitor probe server 6 which are provided in respective different layers of the network, and as a result, results of monitoring of the devices on the network can be obtained with higher accuracy.

Still further, the monitor probe server 4 and the monitor probe server 6 are provided in respective different layers of the network, whereby monitoring results can be obtained with reliability.

Moreover, the monitor probe server 4 and the monitor probe server 6 regularly constantly transmit monitoring commands to the devices to be monitored on the network, the database 5 stores results of the monitoring as a result file, and the monitor server 1 analyzes the contents of the result file every sampling time period, whereby more averaged monitoring results can be obtained.

Further, the database 5 operates like a ring buffer to overwrite the monitoring results onto the result file starting with the first area thereof after writing onto the result file up to the last area thereof. As a result, up-to-date monitoring results over the past sampling time period of five minutes, for example can be obtained.

Moreover, the monitoring results are displayed in a tree structure representation according to the arrangement of the devices to be monitored on the network. As a result, the user can visually determine the monitoring results with ease. Besides, the user can easily identify a location where a fault occurs on the network.

What is claimed is:

1. A network monitoring system comprising:
first monitoring means for determining operating states of devices on a network; and
second monitoring means for monitoring the operating states of the devices on the network, based on an output from said second monitoring means.

2. A network monitoring system as claimed in claim 1, wherein said second monitoring means comprises acquiring means for acquiring the output from said first monitoring means, analysis means for analyzing the acquired output from said first monitoring means, and display means for displaying results of the analysis.

3. A network monitoring system as claimed in claim 2, wherein said display means displays the results of the analysis in a tree structure representation according to an arrangement of the devices on the network.

4. A network monitoring system as claimed in claim 1, wherein said first monitoring means comprises transmitting means for transmitting monitoring commands to the devices on the network, receiving means for receiving responses to the monitoring commands from the devices on the network, and output means for outputting the received responses to said second monitoring means.

5. A network monitoring system as claimed in claim 1, wherein said first monitoring means comprises a plurality of monitor probe servers, said monitor probe servers determining the same devices on the network.

6. A network monitoring system as claimed in claim 5, wherein said monitor probe servers are provided in respective different layers of the network.

7. A network monitoring system as claimed in claim 4, further comprising storage means for storing the output from said first monitoring means in a storage device, and wherein:
said first monitoring means regularly transmit monitoring commands to the devices on the network using said transmitting means, receives responses to the monitoring commands from the devices on the network using said receiving means, and output the received responses to said second monitoring means using said output means;
said storage means stores the output from said first monitoring means in the storage device; and
said second monitoring means analyzes the output from said first monitoring means stored by said storage means every predetermined sampling time period using said analysis means.

8. A network monitoring system as claimed in claim 7, wherein said storage means stores the output from said first monitoring means in the storage device by overwriting the output onto the storage device starting with a first area thereof after writing the output onto the storage device up to a last area thereof.

9. A network monitoring system comprising:
first monitoring means having collecting means for collecting data indicative of results of monitoring devices on a network, and output means for outputting the collected data; and
second monitoring means having storage means for storing the output data, analysis means for analyzing the stored data, and display means for displaying the analyzed data.

10. A network monitoring method comprising:
an operating state-determining step of determining operating states of devices on a network using first monitoring means; and
an operating state-monitoring step of monitoring the operating states of the devices on the network, based on an output from said first monitoring means, using second monitoring means.

11. A network monitoring method as claimed in claim 10, wherein said operating state-monitoring step comprises an acquiring step of acquiring the output from said first monitoring means, an analysis step of analyzing the acquired output from said first monitoring means, and a display step of displaying results of the analysis.

12. A network monitoring method as claimed in claim 11, wherein said display step comprises displaying the results of the analysis in a tree structure representation according to an arrangement of the devices on the network.

13. A network monitoring method as claimed in claim 10, wherein said operating state-determining step comprises a transmitting step of transmitting monitoring commands to the devices on the network, a receiving step of receiving responses to the monitoring commands from the devices on the network, and an output step of outputting the received responses to said second monitoring means for use in monitoring the operating states of the devices on the network in said operating state-monitoring step.

14. A network monitoring method as claimed in claim 10, wherein said first monitoring means comprises a plurality of monitor probe servers, said operating state-determining step comprising determining the same devices on the network by the monitor probe servers.

15. A network monitoring method as claimed in claim 13, further comprising a storing step of storing the output from said first monitoring means in a storage device, and wherein:
in said operating state-determining step, said transmitting step comprises regularly transmitting monitoring commands to the devices on the network, said receiving step comprises receiving responses to the monitoring commands from the devices on the network, and said output means comprises outputting the received responses to said second monitoring means for use in monitoring the operating states of the devices on the network in said operating state-monitoring step;
said storing means comprises storing the output from said first monitoring means in the storage device; and
in said operating state-monitoring step, said analysis step comprises analyzing the output from said first monitoring means stored in said storing step every predetermined sampling time period.

16. A network monitoring method as claimed in claim 15, wherein said storing step comprises storing the output from said first monitoring means in the storage device by overwriting the output onto the storage device starting with a first area thereof after writing the output onto the storage device up to a last area thereof.

17. A network monitoring method comprising:
a first monitoring step having a collecting step of collecting data indicative of results of monitoring devices on a network, and an output step of outputting the collected data; and
a second monitoring step having a storing step of storing the output data, an analysis step of analyzing the stored data, and a display step of displaying the analyzed data.
